(19) United States
(12) Patent Application Publication
(10) Pub. No.: US 2011/0126454 A1
(43) Pub. Date: Jun. 2, 2011

(54) Upside Down Planter Bag

(76) Inventor: Werner Sperzel, Brookfield, WI (US)

(21) Appl. No.: 12/627,453

(22) Filed: Nov. 30, 2009

(51) Int. Cl. A01G 9/02

(52) U.S. Cl. 47/65.8; 47/67; 47/65.5; 47/66.7

(57) ABSTRACT

The invention discloses a planter container made of flexible material in a bag-like shape used to fill, ship and cultivate a plant from seedling to mature plant. The planter can be used both with the plant upright for initial growth and stability during cultivation and shipment and then inverted to an upside down position to hang plants in the home garden. The container can be folded for easy storage and shipment and is inexpensive to manufacture and ship. Due to its versatility, the planter also ensures healthier and unbroken plants due to the upright and stable position of seedlings during cultivation and shipment.

### FIELD OF THE INVENTION

In general, the inventive arrangements relate to a container made entirely of flexible material in a bag-like shape used to fill, ship and cultivate plants, in particular, tomato plants, from seedling to mature plant. The container may be used to cultivate a plant in an upright position for initial growth and stability while in the greenhouse, during shipment and retail display and then inverted by the retail purchaser to an upside down position to hang plants in the home garden. The one-piece bag can be folded for easy storage and shipment and is inexpensive to manufacture.

### BACKGROUND OF THE INVENTION

The invention relates to a container in the nature of a planter bag made entirely of flexible material which is well suited for the cultivation of tomato plants or other types of plants, particularly those capable of growing in an optional “upside down” position. The bag is easy and inexpensive to manufacture and is preferably made of heavy flexible vinyl material, with handles made of woven nylon extending beyond an open top. The bag can be easily and conveniently folded for shipment and storage purposes.

The interior of the planter is easily accessed from the open top to partially fill with soil. After partially filling with soil, the unfilled side of the bag is then folded over the opening with handle straps folded in. In this manner, the bag is closed and then inverted to expose the planting slit in the bottom of the bag. Thereafter, the tomato seedling is planted, either by hand or machine, by pushing the roots through the slit in the bottom of the bag and into the soil in the interior of the planter.

In this manner, the plant initially grows upwardly. The planter can remain in this position, allowing the plants to remain upright during initial greenhouse growth, shipment and even sale if desired. The container can then be inverted and hung upside down from the handles either at the garden center or by the purchaser. Preferably, the bottom of the bag also has holes for drainage and watering and fertilization purposes, allowing water and nutrients to enter the bag when the plant is upright, and allowing drainage from the bag when the plant is inverted to an upside down position.

U.S. Pat. No. 6,874,278 B2, issued Apr. 5, 2005, describes a planter capable of growing plants upside down. However, this patent describes a container that is comprised of many pieces that have to be assembled, including some manufactured of rigid plastic or foam and cable hangers, making it more expensive to manufacture and less flexible for storage and use. Additionally, the invention described in this patent could not be used for the cultivation or shipment of plants in an upright position, thereby costing the grower more money in shipment and care of the plants, in contrast to the current invention described herein.

Successfully growing tomato plants typically requires a garden space with sufficient direct sunlight or a large pot placed in a location where the sunlight is sufficient. Whether in a garden or in a pot, tomato plants typically grow quite tall and, due to the weight of the fruit, require support to maintain their upright position as they mature. This requires a metal or wooden support structure to prevent the plant from falling over due to weight and the force of gravity as the plant grows and bears heavy fruit.

Because a single tomato plant can result in a sizable harvest of tomatoes during the growing season, the plant is well suited to a compact area where only one or two plants are possible due to space concerns. Tomato plants can provide a rewarding harvest from an individual plant. Consequently, the tomato plant is often the plant of choice where there is limited space—for example, on decks or apartment terraces, since these plants provide an ample harvest for minimal effort throughout the growing season.

A significant problem encountered by purchasers when shopping for plants in retail centers is to consider their space and light limitations in their home gardens or outdoor pots. The invention provides an alternative to the need to plant the tomato plant in a traditional garden or pot placed on the ground and rather, allows the plant to grow toward the ground from a bag hanging up.

The invention also overcomes the need for support structures to prevent the force of gravity from making the plant fall over to the ground since it is growing in a downwardly direction out of the bag in the same direction as the force of gravity. Therefore, top-heaviness is not a concern. With an upside down planter bag, the tomato plants can be hung from roof eves, tree branches, or basket hooks anywhere in the yard or garden. They can also be hung from hooks attached to a deck or terrace. Use of the invention allows the plants to be easily accessible so that the home gardener can readily pick the fruit off the vine as the tomatoes ripen to enjoy with a summer meal. The container bag is also easily accessible to the home gardener for watering and fertilizing purposes.

It is an object of the invention to provide an inexpensive, one piece plant container which is lightweight, collapsible and easy to transport and store before use.

It is also desirable to provide a planter that is made of flexible material, so that the top can be folded underneath the plant for easy and stable shipment of a plant in an upright position.

It is an additional object of the invention to provide a container in which a seedling can be planted, shipped and grow throughout the growing season without requiring it to be transplanted into another container.

It is a further object of the invention to provide a container in which a seedling can be planted either by hand or machine.

Still a further object of the invention is to provide a planter that is easy to fill by hand or machine.

Another object of the invention is to provide an inexpensive and safe means to transport a plant to the point of sale without damage to the plant.

It is a further object of the invention to provide an upside down planter that can be used by growers in an upright position in the same manner as traditional pots during initial greenhouse cultivation and shipment.

Another object of the invention is to provide an upside down planter that allows the plant to grow in an upright position during initial cultivation to improve straightness and strength.

Still a further object of the invention is to provide an upside down planter that allows the plant to be sold in an upright position to the consumer, to prevent damage to the plant when it is transported to the purchaser's home garden.

It is also advantageous to provide a planter that can alternatively support the plant whether it is growing in an upright position or hanging so that it grows in a downwardly direction.

### SUMMARY OF THE INVENTION

This invention is a container made of flexible material in a bag-like shape which provides for cultivation and shipment of a plant in both an upright and upside down position. The invention includes a container for planting, transporting and growing a live plant which has a stem, an upper portion and roots. The planter is comprised of a bag-like body having an interior, a side, a bottom and a top, as well as at least one handle attached to the side in close proximity to the top for hanging purposes. The top of the body is open to allow easy access for filling with soil. The bottom of the body has a slit which allows the roots of the plant to be inserted into the soil in the interior of the body for planting. After planting, the stem and the upper portion of the plant extend through the slit in the bottom of the body.

The container is preferably comprised of flexible material, including heavy vinyl. The container is also preferably cylindrical in shape, although other shapes are possible. The handle can be comprised of a strip of woven nylon fabric which is stitched to the side near the top of the body. Where the body is cylindrical, the top and the bottom of the body will be circular in shape.

The planter may have at least one handle which has two opposite ends. Each end of the handle is sewn to the side of the body near the top, approximately 180 degrees across the top from the opposite end. In a preferred embodiment, there may be a first handle and a second handle. The first handle and the second handle will have ends sewn to the side of the body such that each opposite end of the first handle is approximately 45 degrees away from the opposite ends of the second handle.

Further, the bottom may also have at least one hole for watering and drainage purposes. Ideally, the bottom has four holes evenly spaced around the surface, each approximately 45 degrees apart from another hole.

The invention also includes a container for planting, transporting and growing a live plant having a stem, an upper portion and roots which includes a bag-like body having an interior, a side, a bottom and a top. The top is open to receive soil and the bottom has a slit to receive the roots of the plant so that the roots are planted in the soil in the interior of the body and the stem and the upper portion extend outside the body through a slit in the bottom of the body.

Further, the invention also includes a method of planting, transporting and growing plants having roots and a stem in a flexible container having a body with a side, a bottom having a slit therethrough and an open top. This method includes the steps of: (i) holding the open top upright and partially filling the body with soil; (ii) folding the side over the open top; (iii) inverting the body so that the bottom faces in an upwardly direction; (iv) planting a seedling in the container by pushing the roots through the slit into the body into the soil; and (v) transporting the seedling in an upright position, watering and fertilizing is needed from above.

Further still, the invention includes a method of growing a plant in a single container from seedling to maturity in both upright position and upside down position. This method includes the steps of: (i) providing a flexible container with a side, an open top and at least one handle sewn to the side near the top, a bottom having a slit therethrough and at least one hole for drainage and watering; (ii) holding the open top upright and partially filling the body with soil; (iii) folding the side over the open top; (iv) inverting the bottom so that the bottom faces in an upwardly direction; (v) planting a seedling in the container by pushing the roots through the slit into the body into the soil; (vi) transporting the seedling in the body in an upright position, watering and fertilizing from above as needed; and (vii) inverting the body and hanging the body by the handles, such that the plant grows downwardly.

### BRIEF DESCRIPTION OF THE DRAWINGS

Preferred embodiments of the invention are described below with reference to the following drawings, which are provided for illustrative purposes only. The drawings illustrate a best mode contemplated for carrying out the invention. In the drawings:

FIG. 1 is a perspective view of the planter bag in hanging position showing a tomato plant inserted in the bottom of the bag and growing downwardly therefrom, with soil and roots of the plant shown in the interior of the bag in phantom lines;

FIG. 2 is a perspective view of the planter bag shown in FIG. 1, without a plant contained therein;

FIG. 3 is a bottom view of the planter bag shown in FIG. 2;

FIG. 4 is a side view of the planter bag shown in FIG. 1 before the side seam is stitched and the bottom attached, showing the handles stitched to the side of the bag;

FIG. 5 is a perspective view of the planter bag after it is partially filled with soil and a plant is planted in the bottom therein, showing the top portion of the bag folded underneath the soil and plant; and

FIG. 6 is a perspective view of a tray or cart filled with planter bags containing the soil and plants and ready for transport.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE PREFERRED EMBODIMENT

In greenhouses and in retail garden centers, individual plants are typically rooted in soil in small plastic plant containers that are then inserted in larger plant flats. The flats keep the plants upright and secure during shipment. The purchaser typically purchases the plants in the small plastic plant containers, takes them home and replants each seedling in the ground or in another container that is large enough and attractive enough so that the plant can mature throughout the growing season.

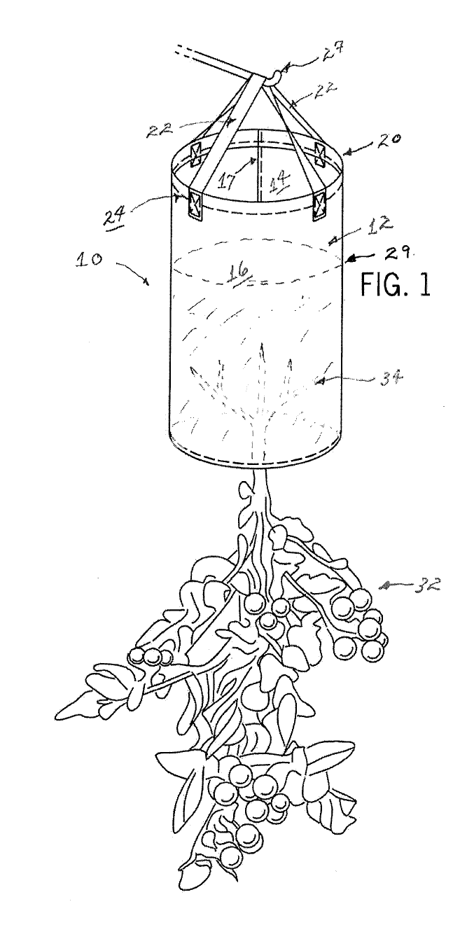

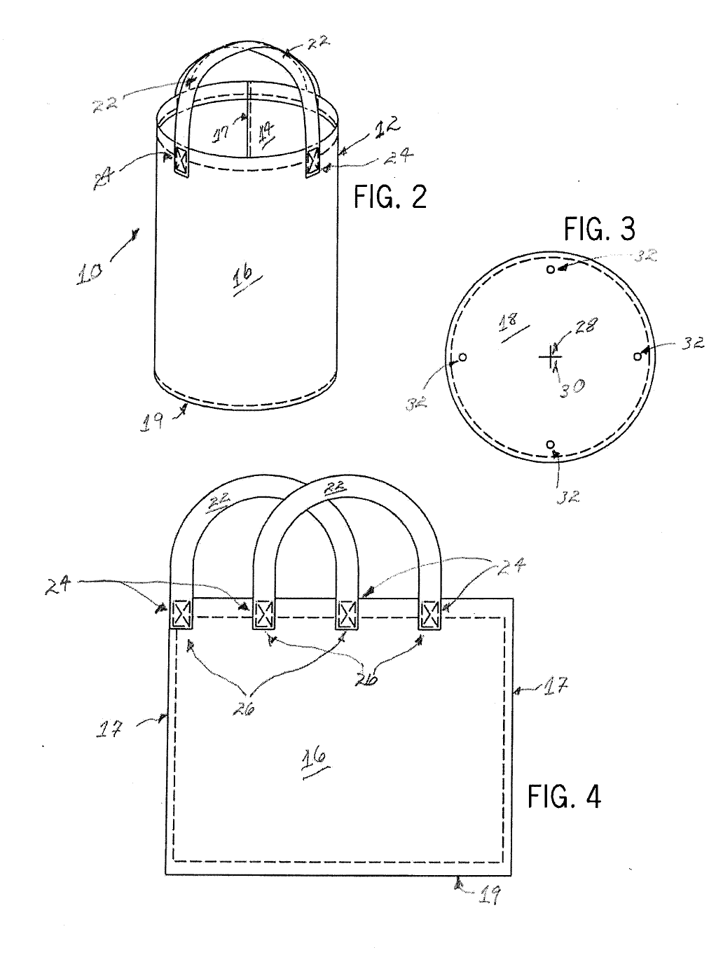

Turning to FIGS. 1-3, the invention provides a container in which a seedling will preferably remain planted from initial planting and cultivation through shipment to its point of sale and thereafter at the purchaser's home throughout the growing season and the maturity of the plant. The planter 10 has a body 12 that has an interior 14, a side 16, a bottom 18 and a top 20. The top 20 of the body 12 is open, allowing for easy filling of soil for planting purposes. The body 12 is preferably made entirely of a flexible, lightweight and waterproof material, such as heavy vinyl, which allows the planter 10 to be collapsed and folded for convenient and inexpensive shipment or storage, since it is very light in weight and takes up very little space when it is folded up.

The overall shape of the body 12 can vary, although a preferred embodiment is cylindrical, allowing the planter 10 to be manufactured from a circular piece forming the bottom 18 stitched to a rectangular piece forming the side 16, as shown in FIGS. 3 and 4. The side 16 is attached to itself by stitching a single side seam 17 to form a cylinder. The bottom 18 is then stitched to the side 16 around its bottom perimeter 19. All stitching is preferably accomplished with thread that is resistant to damage from ultraviolet light. The body 12 is preferably manufactured from heavy vinyl, which retains moisture and heat, resulting in less water loss from the planter 10 and faster plant maturity.

Additionally, a preferred embodiment of the planter 10 includes a handle 22, from which the planter 10 can be hung in an upside down position. The handle 22 is preferably made of woven nylon stitched to the body 12 with thread that is resistant to ultraviolet light damage. However, various alternative materials could be used for hanging purposes, including, without limitation, other fabrics, string, rope, wood or wire.

Ideally, the handle 22 is formed by stitching two pieces of woven nylon of equal length to the top side edge 24 of the body 12 so that each opposite handle end 26 is approximately 180 degrees apart from the other in position around the top side edge 24 of the body 12 and all four opposite handle ends 26 are 90 degrees apart from each other around the top side edge 24 of the top 20 of the body 12 after the side seam 17 is stitched. In this way, one handle 22 crosses over the other handle 22 at the point where the planter 10 will hang from the hanger 27 (see FIG. 4), providing more strength at the point of overlap and even weight distribution for hanging purposes.

Of course, the planter 10 could be manufactured with other types of handles including detachable handles manufactured of other materials and still provide the benefits of a body which can be used in both an upright and upside down position with a plant, and provide easy and stable shipping of plants. However, the use of flexible, pre-attached handles 22 for hanging purposes allows the manufacture, shipment and sale of the planter 10 as a single piece in “ready to use” finished form, which requires no assembly or parts which could be lost or misplaced either by the grower, the shipper or the consumer.

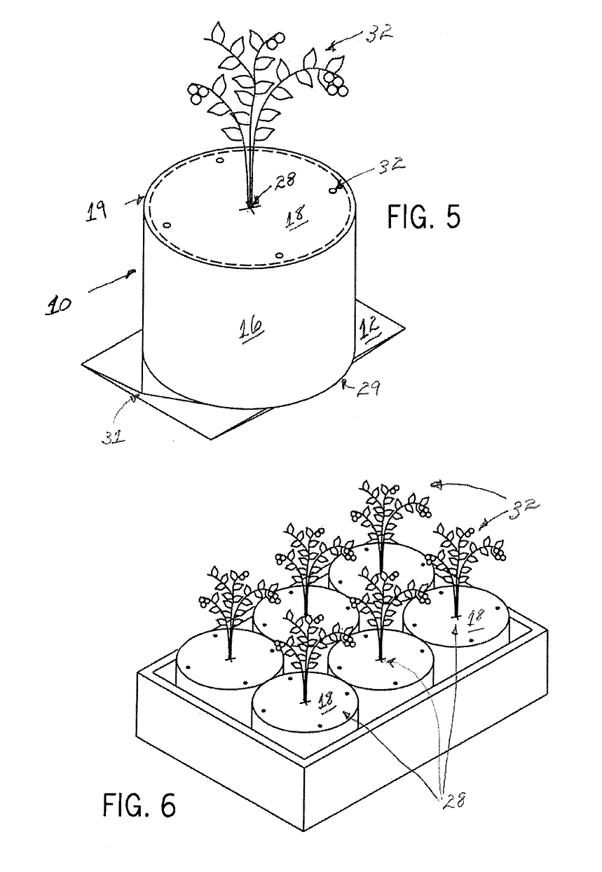

The body 12 in its cylindrical shape, includes a round open top 20 which allows easy access for filling with soil either by hand or by machine. After the body 12 is filled approximately three-quarters full with soil, the material comprising the side 16 above the fill line 29 may be folded over on top of the filled portion of the body 12 and the handles 22 tucked into the fold 31, thereby retaining the soil in position therein. The planter 10 may then be inverted so that the bottom 18 faces up as shown in FIG. 5. The weight of the soil in the planter 10 on top of the fold 31 and the forces of gravity hold and stabilize the planter 10 in place in this upright position.

The bottom 18 of the body 12 has a slit 28, large enough to accommodate the root system of a seedling 32, ordinarily the size of a four inch potted plant. The slit 28 is preferably located in the center 30 of the bottom 18, as shown in FIG. 3. A seedling 32 is easily planted in the planter 10 either by hand or by machine by inserting its roots 34 through the slit 28 and into the soil in the body 12. In a preferred embodiment, the bottom 18 also has several holes 32, evenly spaced across the bottom 18 to provide a means of providing access for water and nutrients to the roots 34 of the seedling 32 in the soil when the planter 10 is in an upright position for shipment, sale and transport to the consumer's home garden. These same holes 32 provide adequate drainage for the planter 10 when it is used in the upside down hanging position.

After the seedling 32 is planted in the planter 10, the seedling 32 can remain in the planter 10 in upright position until it further matures. This provides an added benefit of stronger roots 34 than if the planter 10 required the seedling 32 to grow upside down from initial planting. The initial growth in an upright position also results in seedlings 32 that are straighter and sturdier than those which are grown upside down from the start.

A significant advantage of the invention is the versatility of being able to grow the plant upright or, alternatively, upside down. This makes the use of the planter 10 much easier for the commercial grower since the seedling 32 can be grown in the same manner as any other potted plant. The planter 10 can also be shipped with the seedling 32 in upright position like other potted plants. Additionally, the customer doesn't have to be concerned about how to get the planter 10 home safely, since it can be put in a bag or box with the seedling 32 in an upright position, or alternatively, hung in the upside down position. One additional advantage to the consumer of the planter 10 is that after the planter 10 is hanging in the home garden, there is additional room above the fill line 29 that can be planted with herbs, flowers or another vegetable plant.

The invention can be manufactured at a substantially lower cost than other upside down growing devices. The invention also saves the grower costs in shipping expenses because the planter 10 does not take up more space or weigh more than a traditional pot and because the planter 10 can be shipped like traditional pots with the seedling 32 in an upright position,

In order to use the invention, the grower holds the open top 20 facing up, moves the handles 22 away from the top 20 and fills the body 12 about three-quarters full with soil by machine or hand. Unlike other upside down bags, the planter 10 is capable of being filled by machine on a conveyor in a commercial operation if desired, thereby saving the grower considerable costs.

After the body 12 is filled to the fill line 29, the material remaining at the top 20 of the body 12 is folded over the top 20, thereby closing it and tucking the handles 22 into the fold 31. With the top of the planter 10 folded shut, the planter 10 is turned over so the top 20 stays folded in position underneath the soil and the bottom 18 is on top. The bottom 18, having the slit 28 and holes 32 for watering and drainage purposes, is then used to plant the seedling 32.

The seedling 32 can be planted by hand or by mechanical means, just like a vegetable in a pot, by pushing the roots 34 through the slit 28 into the body 12 and the soil within the interior 14 of the planter 10. The seedling 32 in its upright position can then be watered and fertilized as needed from above through the holes 32 in the bottom 18. The planter 10 can be moved, if desired, on a conveyer belt in a commercial operation from the planting area to the greenhouse benches.

If commercially shipped, the planter 10 can be transported on a cart in the same manner as a traditional pot would be transported. Additionally, shipping would be in the same manner as any other potted item in the greenhouse because the seedling 32 grows upright in the same manner as those growing in pots. For example, as shown in FIG. 6, a group of planters 10 could be put on a cart for shipment in the same manner as traditional pots. Having the ability to use the planter 10 in an upright position for commercial growing purposes allows easy shipping in a upright position side-by-side and saves substantial space over traditional upside down planters. Shipping upright also keeps the seedling 32 from being damaged since it is easier to keep it in a stable position and it is therefore less vulnerable to bouncing, swaying and breakage.

An added advantage to the planter 10 over other upside down planter devices is that the seedling 32 will grow straight up toward the light, which provides for normal growth, resulting in a plant that is ready to ship earlier than a plant that would be growing upside down and would need to reach around towards the light due to its upside down position during the early phases of growth.

At retail centers, multiple planters 10 can be displayed as if they were potted to save room or they can alternatively be hung by the handles from a hanger or other device. If the planter 10 is displayed as potted plant, with the seedling 32 in upright position, the consumer can take the planter 10 home in a bag or a box, similar to a traditional potted plant, which safeguards the stability of the seedling 32 in transport to the home garden, thereby ensuring an arrival to the home garden in good condition, where the planter can then be hung by the home gardener where desired.

It is understood that the various preferred embodiments are shown and described above to illustrate different possible features in the invention and the varying ways these features may be combined. Apart from combining the different features of the above embodiments and varying ways, other modifications are also considered to be within the scope of the invention.

The invention is not intended to be limited to the preferred embodiments described above, but rather is intended to be limited only by the claims setout below. Thus, the invention encompasses all alternate embodiments that fall literally or equivalently within the scope of these claims.

What is claimed is:

1. A container for planting, transporting and growing a live plant having a stem, an upper portion and roots, comprising;
a bag-like body having an interior, a side, a bottom and a top;
at least one handle attached to the side in close proximity to the top for hanging purposes;
wherein the top is open to receive soil; and
wherein the bottom has a slit to receive the roots therethrough, whereby the roots are planted in the soil in the interior of the body and the stem and upper portion extend outside the body through a slit in the bottom of the body.

2. The invention of claim 1, wherein the body is comprised of flexible material.

3. The invention of claim 2, wherein the body is comprised of heavy vinyl.

4. The invention of claim 3, wherein the container is cylindrical in shape.

5. The invention of claim 2, wherein at least one handle is comprised of a strip of woven nylon fabric stitched to the side near the top of the body.

6. The invention of claim 5, wherein the top and the bottom of the body are circular in shape and further wherein at least one handle has two opposite ends and each end is sewn to the side of the body approximately 180 degrees apart from the opposite end.

7. The invention of claim 6, wherein there is a first handle and a second handle, the first handle and the second handle having ends sewn to the side of the body such that each opposite end of the first handle is approximately 45 degrees away from the opposite ends of the second handle.

8. The invention of claim 7, wherein the bottom has at least one hole therethrough for watering and drainage purposes.

9. The invention of claim 8, wherein the bottom has four holes, evenly spaced around the surface, each approximately 45 degrees apart from another hole.

10. A container for planting, transporting and growing a live plant, having a stem, an upper portion and roots, comprising;
A bag-like body having an interior, a side, a bottom and a top;
wherein the top is open to receive soil; and
wherein the bottom has a slit to receive the roots therethrough, whereby the roots are planted in the soil in the interior of the body and the stem and upper portion extend outside the body through a slit in the bottom of the body.

11. The invention of claim 10, wherein the body is comprised of flexible material.

12. The invention of claim 11, wherein the body is comprised of heavy vinyl.

13. The invention of claim 12, wherein the container is cylindrical in shape.

14. A method of planting, transporting and growing plants having roots and a stem in a flexible container having a body with a side, a bottom having a slit therethrough and an open top, by taking the following steps:
a. Holding the open top upright and partially filling the body with soil;
b. Folding the side over the open top;
c. Inverting the body so that the bottom faces in an upwardly direction;
d. Planting a seedling in the container by pushing the roots through the slit into the body and the soil; and
e. Transporting the seedling in an upright position, watering as needed from above.

15. A method of growing a plant in a single flexible container from seedling to maturity in both upright position and upside down position by taking the following steps:
a. Providing a flexible container with a side, an open top, at least one handle sewn to the side near the top, a bottom having a slit therethrough and at least one hole for drainage and watering;
b. Holding the open top upright, partially filling the body with soil;
c. Folding the side over the open top to retain the soil therein;
d. Inverting the body so that the bottom faces in an upwardly direction;
e. Planting a seedling in the container by pushing the roots through the slit into the body and the soil;
f. Transporting the seedling in the body in an upright position, watering from above as needed; and
g. Inverting the body and hanging the body by the handle such that the plant grows downwardly.
